(19) United States
(12) Patent Application Publication
(10) Pub. No.: US 2014/0031100 A1
(43) Pub. Date: Jan. 30, 2014

(54) WAGERING GAME WITH MULTIPLE UNLOCKABLE ARRAYS

(71) Applicant: WMS GAMING INC., Waukegan, IL (US)

(72) Inventors: Benjamin T. Gomez, Chicago, IL (US); Daniel P. Louie, Chicago, IL (US)

(73) Assignee: WMS Gaming Inc., Waukegan, IL (US)

(21) Appl. No.: 13/794,204

(22) Filed: Mar. 11, 2013

Related U.S. Application Data
(60) Provisional application No. 61/676,053, filed on Jul. 26, 2012.

(51) Int. Cl. G07F 17/34

(52) U.S. Cl. CPC G07F 17/34
USPC 463/20

(57) ABSTRACT

A gaming system for conducting a wagering game includes an input device, a display device, a processor, and a memory device. The memory device stores instructions that, when executed by the processor, cause the gaming system to receive a wager in response to an input, display a main array of symbol-bearing reels, and to display a plurality of enhanced arrays. The main array includes a plurality of enhanced-array triggers. Each enhanced array includes an enhancement feature and each enhanced array is associated with at least one of the plurality of enhanced-array triggers. The enhanced arrays are spun and evaluated upon display of the associated enhanced-array triggers.

### CROSS-REFERENCE TO RELATED APPLICATIONS

This application claims the benefit of U.S. Provisional Patent Application 61/676,053, filed on Jul. 26, 2012, which is hereby incorporated by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to displaying multiple enhanced arrays that are unlockable.

### BACKGROUND OF THE INVENTION

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to one aspect of the present invention, a gaming system for conducting a wagering game includes at least one input device, at least one display device, at least one processor, and at least one memory device. The memory device stores instructions that, when executed by the at least one processor, cause the gaming system to receive a wager in response to an input via the at least one input device, display on the at least one display device a main array with a plurality of symbol-bearing reels, display on the at least one display device a plurality of enhanced arrays, and spin and evaluate the plurality of symbol bearing reels on the main array in response to the wager. The plurality of symbol-bearing reels on the main array includes a plurality of enhanced-array triggers. Each of the plurality of enhanced arrays includes a plurality of symbol-bearing reels and an enhancement feature. The enhancement feature of each enhanced array is different from any other enhancement feature of the plurality of enhanced arrays. Each of the plurality of enhanced arrays is associated with at least one of the plurality of enhanced-array triggers. The instructions further cause the gaming system to spin and evaluate the plurality of symbol-bearing reels on the enhanced array associated with a displayed enhanced-array trigger in response to the main array displaying at least one enhanced-array trigger.

According to another aspect of the invention, a method of conducting a wagering game on a gaming system includes receiving a wager in response to an input via at least one input device, displaying a main array including a plurality of symbol-bearing reels on at least one display device, displaying a first enhanced array and a second enhanced array on at least one display device, and spinning and evaluating the plurality of symbol-bearing reels on the main array in response to receiving a wager. The plurality of symbol-bearing reels on the main array includes a first enhanced-array trigger symbol associated with only the first enhanced array and a second enhanced-array trigger symbol associated with only the second enhanced array. Each of the enhanced arrays includes a plurality of symbol-bearing reels and an enhancement feature. The enhancement feature of each enhanced array is different from the enhancement features of any other enhanced array. The plurality of symbol-bearing reels on the first enhanced array are spun and evaluated in response to the first enhanced-array trigger symbol being displayed on the at least one display. The plurality of symbol-bearing reels on the second enhanced array are spun and evaluated in response to the second enhanced-array trigger symbol being displayed on the at least one display.

According to yet another aspect of the invention, a method of conducting a wagering game on a gaming system includes receiving a wager in response to an input via at least one input device, displaying a main array having a plurality of symbol-bearing reels on at least one display device, and displaying a plurality of enhanced arrays on at least one display device. The plurality of symbol-bearing reels on the main array includes a plurality of enhanced-array triggers. Each of the plurality of enhanced arrays includes a plurality of symbol-bearing reels and an enhancement feature. The enhancement feature of each enhanced array is different from any other enhancement feature of the plurality of enhanced arrays. Each of the plurality of enhanced arrays is associated with at least one of the plurality of enhanced-array triggers. The plurality of symbol-bearing reels on the main array are spun and evaluated in response to the received wager. The plurality of symbol-bearing reels of each enhanced array are spun and evaluated in response to the associated enhanced array-trigger being displayed on the main array.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an embodiment of the present invention.

FIG. 2 is a schematic view of a gaming system according to an embodiment of the present invention.

FIG. 3 is an image of an exemplary basic-game screen of a wagering game displayed on a gaming terminal, according to an embodiment of the present invention.

FIG. 4A is an exemplary screen having a main array and three locked enhanced arrays.

FIG. 4B is the exemplary screen of FIG. 4A having one of the enhanced arrays unlocked.

FIG. 4C is the exemplary screen of FIG. 4A having all of the enhanced arrays unlocked.

FIG. 5 is a flowchart for an algorithm that corresponds to instructions executed by a controller in accord with at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

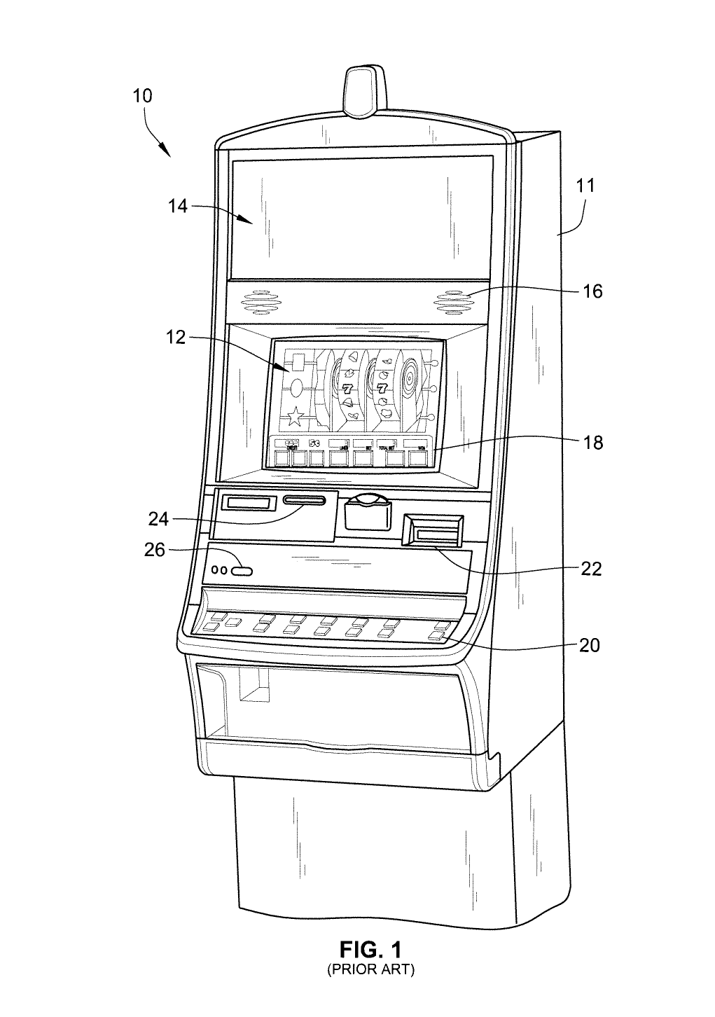

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0069160 and US2010/0234099, which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

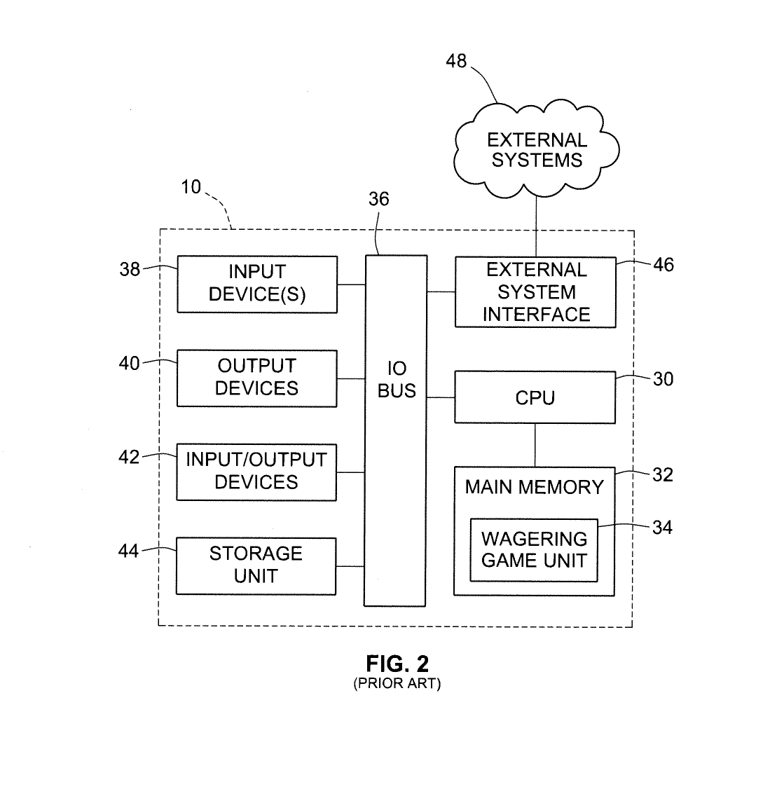

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

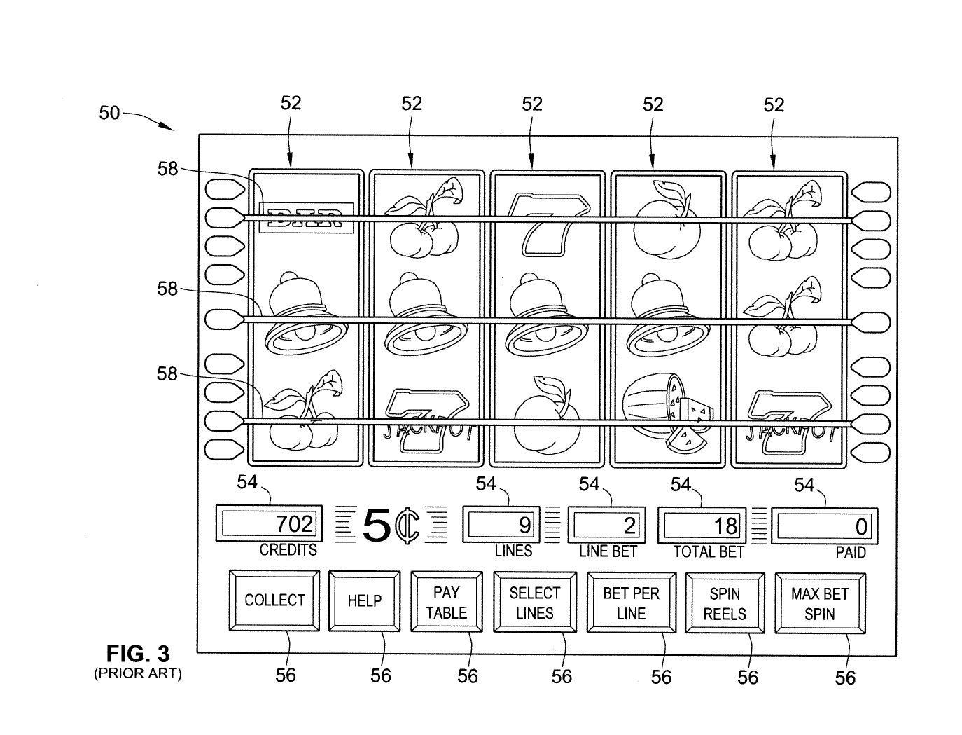

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

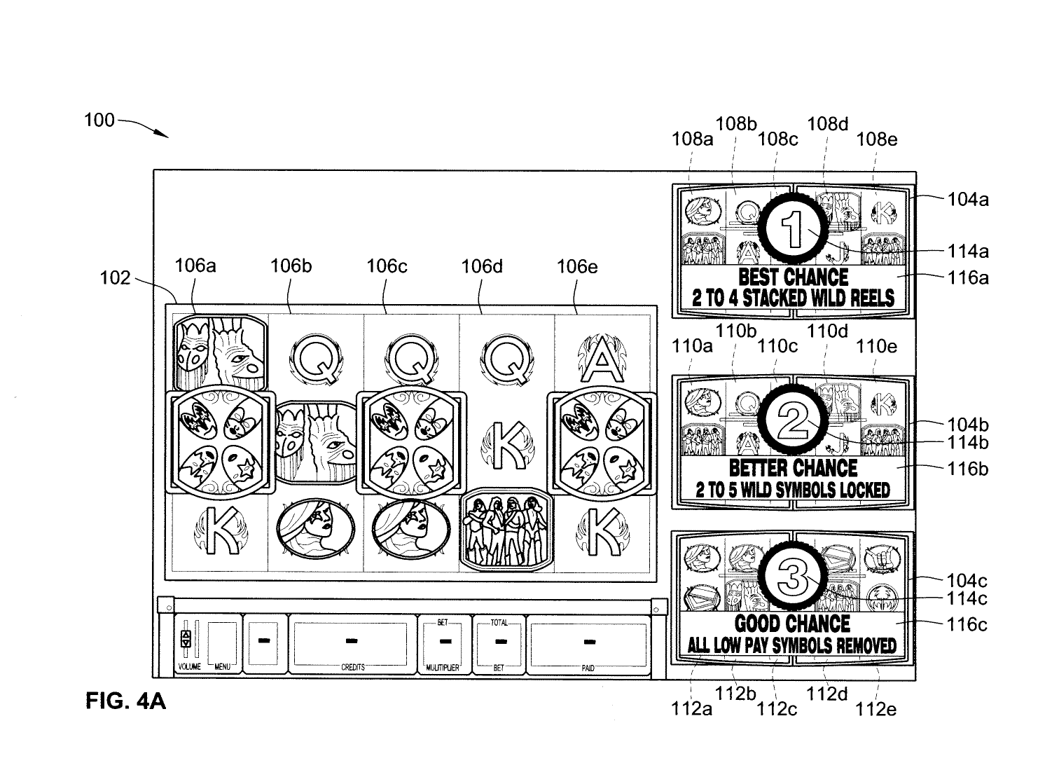

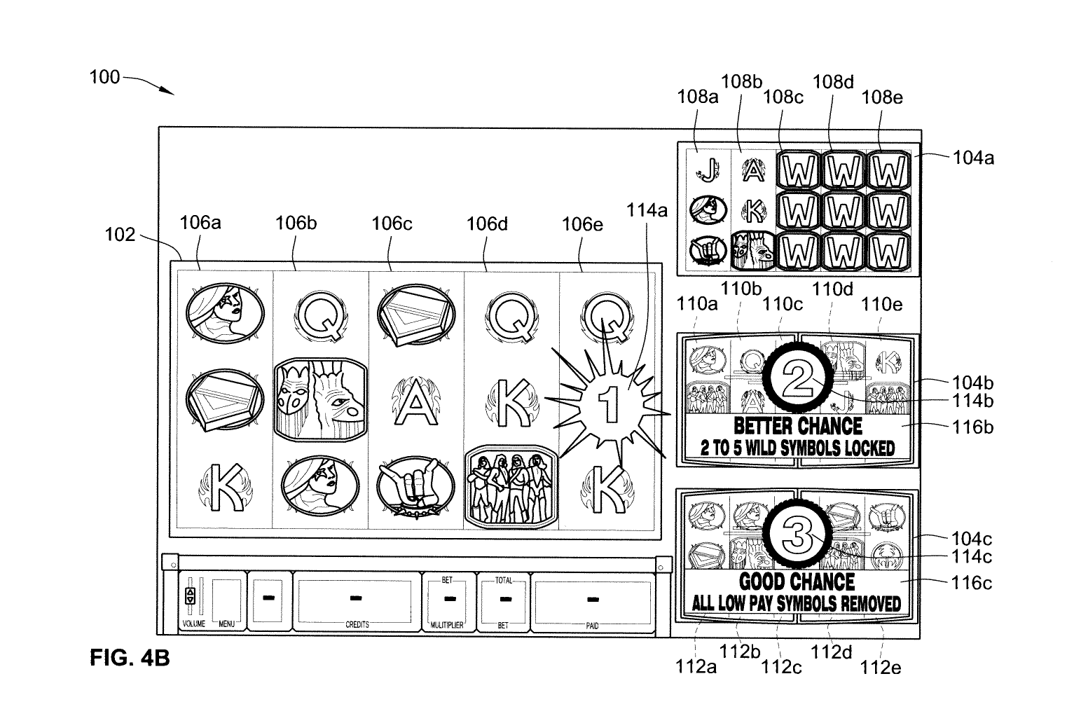

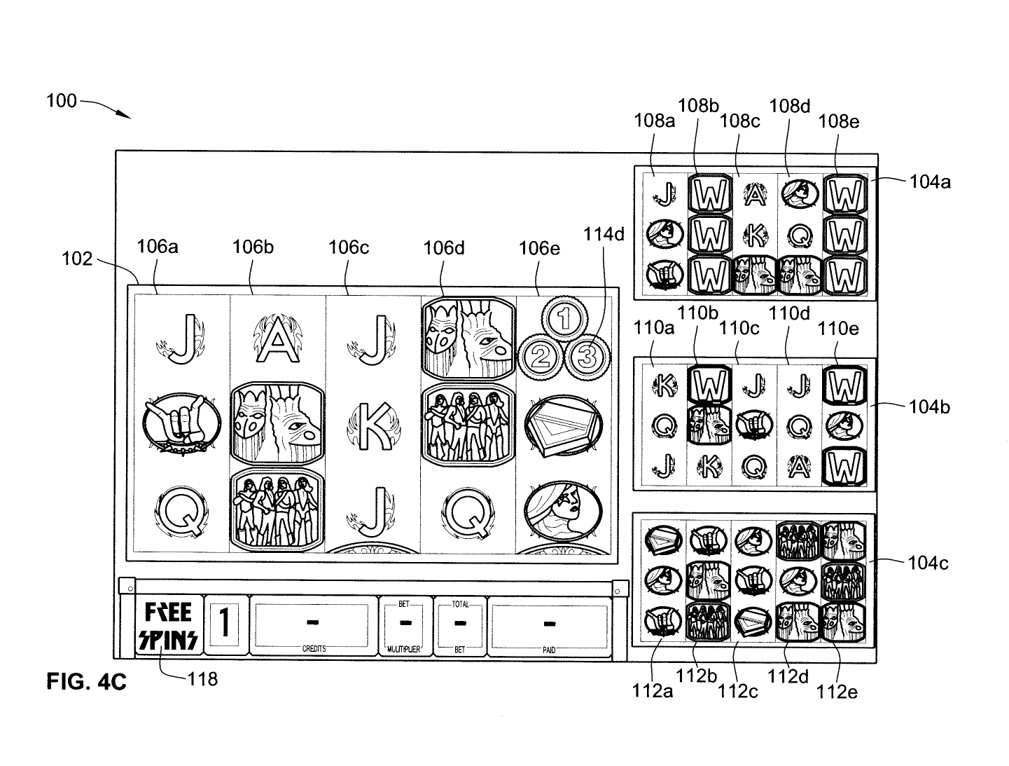

Referring now to FIGS. 4A-4C, a wagering game screen 100 is shown. The wagering game screen 100 includes a main array 102 and three enhanced arrays 104a-104c. The main array 102 includes a plurality of main-array reels 106a-106e. A first enhanced array 104a includes a plurality of first-enhanced-array reels 108a-108e. Similarly, a second enhanced array 104b includes a plurality of second-enhanced-array reels 110a-110e and a third enhanced array 104c includes a plurality of third-enhanced-array reels 112a-112e. The main array 102 may be presented in either a base game or a bonus event of the wagering game. Similarly, the enhanced arrays 104a-104c may be displayed with the main array 102 or as a separate bonus feature. The enhanced arrays 104a-104c are locked until a triggering condition is met.

Referring now to FIG. 4A, each of the enhanced arrays 104a-104c is visually associated with a respective enhanced-array trigger symbol 114a-114c when locked. Additionally, this display informs the player of the particular enhanced-array trigger symbol 114a-114c required to unlock the particular enhanced array 104a-104c. When locked, the enhanced arrays 104a-104c are not eligible to provide an award to a player in response to a winning combination. It is contemplated that other methods may be used to signify when an enhanced array is not currently in play.

Each enhanced array 104a-104c also includes at least one enhancement feature 116a-116c associated with it. As will be described in detail in connection with FIG. 4B, the first enhanced array 104a is associated with a “wild reels” enhancement feature 116a. As will be described in connection with FIG. 4C, the second enhanced array 104b is associated with a “random wilds” enhancement feature 116b and the third enhanced array 104c is associated with a “reduced symbol set” enhancement feature 116c. It is contemplated that other enhancement features may be used such as free spins, an increased number of bonus event trigger symbols, respins, additional paylines, clumped symbols, locking symbols, loaded reels, etc. Additionally, multiple enhancements may be used on any of the three enhanced arrays 104a-104c and/or the enhanced arrays 104a-104c may share some enhancement features.

Referring now to FIG. 4B, the main array 102 is shown displaying a triggering condition to unlock an enhanced array. In this embodiment, the triggering condition is any enhanced-array trigger symbol 114a-114d being displayed on the rightmost main-array reel 106e. The enhanced-array trigger symbol 114a-114d “unlocks” the particular enhanced array 104a-104c or particular enhanced arrays associated with it. After the wagering game outcome is determined and a first-enhanced-array trigger symbol 114a is displayed, the first enhanced array 104a (i.e., the enhanced array associated with trigger symbol 114a) is unlocked and the display of the first enhanced array 104a is altered. The illustrated “wild reels” enhancement feature 116a (FIG. 4A) is utilized in the first enhanced array 104a by the gaming system. The gaming system selects a random number of the first-enhanced-array reels 108a-108e to be replaced with wild reels. In the illustrated embodiment, the number of reels to be replaced ranges from two to four. The gaming system then selects the positions of the first-enhanced-array reels 108a-108e to be replaced with the wild reels. In the illustrated embodiment, the CPU 30 has randomly selected the three rightmost first-enhanced-array reels 108c-108e to be replaced by wild reels. In some embodiments, the selected wild reels are locked in place while the remaining two leftmost first-enhanced-array reels 108a and 108b are spun. A game outcome is determined based on the arrangement of symbols randomly selected from spinning the two leftmost first-enhanced-array reels 108a and 108b combined with the wild symbols already selected on the three rightmost first-enhanced-array reels 108c-108d.

Referring now to FIG. 4C, a multiple-enhanced-array trigger symbol 114d is displayed on the fifth reel 106e of the main array 102 and is associated with all three enhanced arrays 104a-104c. It is contemplated that additional combinations of enhanced-array trigger symbols 114a-114d may be included that are associated with more than one, but less than all, of the enhanced arrays 104a-104b. As described above, the “wild reels” enhancement feature 116a (FIG. 4A) is applied to the first enhanced array 104a. In this illustration, the second first-enhanced-array reel 108b and the rightmost first-enhanced-array reel 108e were selected to be wild reels using the method stated above.

The “random wilds” enhancement feature 116b (FIG. 4A) is applied to the second enhanced array 104b when the second enhanced array 104b is unlocked. The illustrated “random wilds” enhancement feature 116b (FIG. 4A) is applied to the second enhanced array 104b by the gaming system. The gaming system selects a random number of symbols to be replaced on the second enhanced array 104b. In the illustrated embodiment, the number of symbols to be replaced ranges from two to five. The gaming system selects the positions of the symbols to be replaced on second-enhanced-array reels 110a-110e to be replaced by wild symbols. In the illustrated embodiment, the CPU 30 has randomly selected three array positions to be replaced with wild symbols. These array positions are located at the top of the second second-enhanced-array reel 110b, as well as the top and bottom of the rightmost second-enhanced-array reel 110e. In some embodiments, the selected wild symbols are locked in place on the second enhanced array 104b while the second-enhanced-array reels 110a-110e are spun. A game outcome is then determined based on the locked wild symbols and on the randomly selected symbols displayed on the remaining positions of the second enhanced array 104b.

The illustrated “reduced symbol set” enhancement feature 116c (FIG. 4A) is applied to the third enhanced array 104c by the gaming system after the third enhanced array 104c is unlocked. In the illustrated embodiment, the “reduced symbol set” enhancement feature 116c includes a plurality of symbols arranged on the plurality of the third-enhanced-array reels 112a-112e of the third enhanced array 104c. The set of symbols on the third-enhanced-array reels 112a-112e includes symbols used on the main array 102, but excludes the lowest paying symbols in that set. The number of symbols excluded from the third-enhanced-array reels 112a-112e may be varied to achieve a desired result. By way of non-limiting example, the set of excluded symbols can be a predetermined set or can be randomly determined by the gaming system during play of the wagering game.

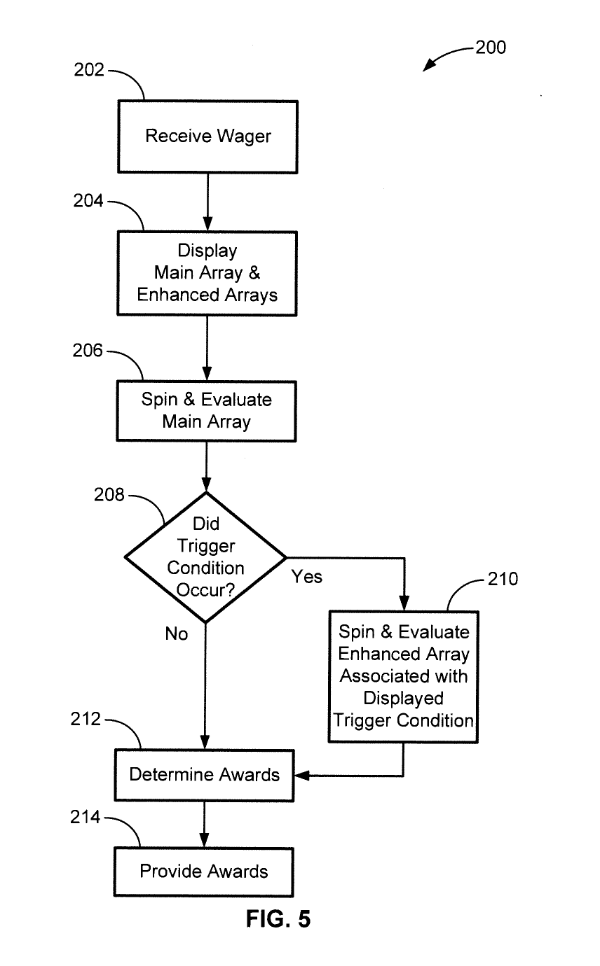

FIG. 5 illustrates a schematic depiction of one algorithm that corresponds to at least some instructions that can be executed by the CPU 30 and/or external systems 48 to perform the above described functions associated with the disclosed concepts. By way of non-limiting example, the exemplary algorithm 200 includes receiving a wager, at step 202, from a player to initiate a wagering game. The wager is placed or otherwise confirmed, for example, using a bill validator 22, coin acceptor, information reader 24, or other input device. A main array and enhanced arrays are displayed at step 204 (e.g., the main array 102 and enhanced arrays 104a-104c of FIG. 4A). It is contemplated that the main array and the enhanced arrays can also be displayed prior to initiation of the wagering game.

After receiving the wager from the player, a game outcome is generated. In the illustrated embodiment, the main array includes a plurality of symbol-bearing reels that are spun and evaluated at step 206 (e.g., the main-array reels 106a-106e of FIGS. 4A-4C). It is determined, at decision box 208, whether a triggering condition has occurred that enables play of any enhanced arrays (e.g., as shown in FIG. 4B, the first-enhanced-array trigger symbol 114a being displayed on the rightmost main-array reel 106e allows play of the first enhanced array 104a). If a triggering condition has not occurred, an award determination is made at step 212 to evaluate whether the main array resulted in an award to the player. Alternatively, if a triggering condition has occurred, at least one enhanced array associated with the triggering condition is unlocked and the symbol-bearing reels on the unlocked enhanced array are spun and evaluated at step 210.

In the illustrated embodiment, the unlocked enhanced array includes a plurality of symbol-bearing reels (e.g., the first-enhanced-array reels 108a-108e shown in FIG. 4B). It is contemplated that multiple triggering conditions may occur simultaneously and that either all or fewer than all enhanced arrays associated with the triggering conditions may be played. It is further contemplated that multiple enhanced arrays may be associated with a single trigger symbol (e.g., the multiple-enhanced-array trigger symbol 114d shown in FIG. 4C). After the enhanced array has been spun and evaluated at step 210, an award determination is made at step 212 to evaluate whether the main array, enhanced array, both, or neither resulted in an award to the player. These awards are based on, for example, combinations of symbols displayed on the main array and symbols displayed on any unlocked array. The player is provided with any determined awards at step 214 and play of the wagering game may continue.

In some embodiments, play of the unlocked enhanced arrays can unlock other of the enhanced arrays or cause the main array to respin. For example, play of the first enhanced array 104a can result in displaying a second-enhanced-array trigger symbol 114b that unlocks the second enhanced array 104b. Or, in another example, play of the first enhanced array 104a can result in a respin symbol that causes the main array 102 to respin one or more times. Furthermore, the respinning of the main array 102 can potentially unlock other enhanced arrays, for example, a third-enhanced-array trigger symbol 114c unlocks the third enhanced array 104c.

In some embodiments, the number of enhanced-array trigger symbols 114a-114d increases if a free-spin bonus game is triggered on the main array 102. In this embodiment, the plurality of main-array reels 106a-106e includes only three enhanced-array trigger symbols 114a-114c during the base game, each of the enhanced-array trigger symbols 114a-114c being able to unlock a single and distinct one of the enhanced arrays 104a-104c. When a free-spin bonus is initiated, as indicated by an information area 118 (FIG. 4C), the multiple-enhanced-array trigger symbol 114d is added to the plurality of symbol positions on at least one of the main-array reels 106a-106e. The multiple-enhanced-array trigger symbol 114d is able to unlock all three enhanced arrays 104a-104c simultaneously. Alternatively, during a free-spin bonus game, all of the single, enhanced-array trigger symbols 114a-114c convert to multiple-enhanced-array trigger symbols 114d.

In yet other embodiments, the number of enhanced-array trigger symbols 114a-114d does not change when the free-spin bonus is initiated. In this embodiment, an enhanced array that becomes unlocked due to a triggering condition remains unlocked and is spun and evaluated for the remainder of the free spins. For example, if the free-spin bonus has ten free spins and the first enhanced array 104a is unlocked during the third free spin, the first enhanced array 104a remains unlocked and is spun and evaluated for each of the remaining seven spins (in addition to the third spin).

While the present devices have been described using a single-symbol trigger on the rightmost main-array reel 106e, it is contemplated that a single-symbol trigger may be implemented on any of the main-array reels 106a-106e. In alternative embodiments, a combination of symbols or a specific placement of symbols may be required to unlock the enhanced arrays. This requirement can include a trigger with three symbols where all three symbols indicate the enhanced array to be unlocked. For example, in reference to FIG. 4B, two additional first-enhanced-array trigger symbols 114a would be required to be displayed on any of the main-array reels 106a-106e. Alternatively, the three first-enhanced-array trigger symbols 114a could be required to be located in a specific location or orientation (e.g., all three symbols must be located in a top position on any of the main-array reels 106a-106e of the main array 102). In yet another alternative, the three symbols could be different from one another (e.g., one symbol identifies the enhanced array to be unlocked and the other two symbols are generic bonus symbols).

Each of these embodiments and obvious variations thereof is contemplated as falling within the spirit and scope of the claimed invention, which is set forth in the following claims.

What is claimed is:

1. A gaming system comprising:
one or more input devices;
one or more display devices;
one or more processors; and
at least one memory device storing instructions that, when executed by at least one of the one or more processors, cause the gaming system to:
receive a wager in response to an input via at least one of the one or more input devices;
display on at least one of the one or more display devices a main array having a plurality of symbol-bearing reels, the plurality of symbol-bearing reels including a plurality of enhanced-array triggers;
display on at least one of the one or more display devices a plurality of enhanced arrays, each of the plurality of enhanced arrays having a plurality of symbol-bearing reels and an enhancement feature, a first enhancement feature of a first of the plurality of enhanced arrays being different from a second enhancement feature of a second of the plurality of enhanced arrays, each of the plurality of enhanced arrays being associated with a respective at least one of the plurality of enhanced-array triggers;
in response to receiving the wager, spin and evaluate the plurality of symbol-bearing reels on the main array; and
in response to the main array displaying at least one enhanced-array trigger of the plurality of enhanced-array triggers, spin and evaluate the plurality of symbol-bearing reels of any enhanced array associated with the displayed at least one enhanced-array trigger.

2. The gaming system of claim 1, wherein the plurality of symbol-bearing reels in the first enhanced array includes at least one enhanced-array trigger associated with the second enhanced array.

3. The gaming system of claim 1, further comprising a base wagering game and a bonus event.

4. The gaming system of claim 3, wherein an initial number of triggers in the plurality of enhanced-array triggers is modified during the bonus event.

5. The gaming system of claim 4, wherein the initial number of triggers in the plurality of enhanced-array triggers is increased by adding at least one enhanced-array trigger.

6. The gaming system of claim 1, wherein at least one of the plurality of enhanced-array triggers is associated with more than one enhanced array.

7. The gaming system of claim 1, further comprising a bonus event in which a plurality of spins are awarded, the bonus event including:
unlocking at least one of the plurality of enhanced arrays during one of the spins of the plurality of spins; and
spinning and evaluating the main array and any unlocked ones of the plurality of enhanced arrays during each of any remaining spins of the plurality of spins.

8. The gaming system of claim 1, wherein, in response to displaying at least one other enhanced-array trigger in the enhanced array associated with the displayed at least one enhanced-array trigger, the plurality of symbol-bearing reels of another enhanced array of the plurality of enhanced arrays is spun and evaluated.

9. A computer-implemented method in a gaming system, comprising:
receiving a wager in response to an input via at least one of one or more input devices;
displaying on at least one of one or more display devices a main array including a plurality of symbol-bearing reels, the plurality of symbol-bearing reels including a first enhanced-array trigger condition associated with a first enhanced array and a second enhanced-array trigger condition associated with a second enhanced array;
displaying on at least one of the one or more display devices the first enhanced array and the second enhanced array, the first enhanced array including a first enhancement feature, the second enhanced array including a second enhancement feature, the first enhancement feature being different from the second enhancement feature, each of the first and the second enhanced array including a plurality of symbol-bearing reels;
in response to receiving the wager, spinning and evaluating the plurality of symbol-bearing reels on the main array;
in response to the main array displaying the first-enhanced-array trigger condition, using at least one of one or more processors to spin and evaluate the plurality of symbol-bearing reels of the first enhanced array;
in response to the main array displaying the second-enhanced-array trigger condition, using at least one of the one or more processors to spin and evaluate the plurality of symbol-bearing reels of the second enhanced array; and
wherein the first-enhanced-array trigger condition is associated with only the first enhanced array and the second-enhanced-array trigger condition is associated with only the second enhanced array.

10. The computer-implemented method of claim 9, wherein the plurality of symbol-bearing reels in the first enhanced array includes at least one trigger condition associated with the second enhanced array.

11. The computer-implemented method of claim 9, wherein the plurality of symbol-bearing reels of the second enhanced array includes the first-enhanced-array trigger condition.

12. The computer-implemented method of claim 9, further comprising, in response to at least one of the first-enhanced-array trigger condition and the second-enhanced-array trigger condition being displayed on any of the first enhanced array and the second enhanced array, spinning and evaluating the respective one of the first enhanced array and the second enhanced array associated with the displayed trigger condition of the first-enhanced-array trigger condition and the second-enhanced-array trigger condition.

13. The computer-implemented method of claim 9, further comprising a base wagering game and a bonus event, the bonus event including a plurality of spins.

14. The computer-implemented method of claim 13, further comprising:
in response to triggering the bonus event, spinning and evaluating the main array and all unlocked enhanced arrays until all of the plurality of spins are spun and evaluated;
wherein the first enhanced array is unlocked when the first-enhanced-array trigger condition is satisfied during one of the spins and the second enhanced array is unlocked when the second-enhanced-array trigger condition is satisfied during one of the spins.

15. The computer-implemented method of claim 14, wherein the first enhanced array and the second enhanced array remain unlocked for each of any remaining spins.

16. A computer-implemented method in a gaming system, comprising:
receiving a wager in response to an input via at least one of one or more input devices;
displaying on at least one of one or more display devices a main array having a plurality of symbol-bearing reels, the plurality of symbol-bearing reels including a plurality of enhanced-array triggers;
displaying on at least one of the one or more display devices a plurality of enhanced arrays, each of the plurality of enhanced arrays having a plurality of symbol-bearing reels and an enhancement feature, a first enhancement feature of a first of the plurality of enhanced arrays being different from a second enhancement feature of a second of the plurality of enhanced arrays, each of the plurality of enhanced arrays being associated with at least one of the plurality of enhanced-array triggers;
in response to receiving the wager, spinning and evaluating, by at least one of one or more processors, the plurality of symbol-bearing reels of the main array;
in response to displaying at least one of the plurality of enhanced-array triggers, unlocking, by at least one of the one or more processors, an associated array of the plurality of enhanced arrays; and
spinning and evaluating, by at least one of the one or more processors, the plurality of symbol-bearing reels of the unlocked associated array.

17. The computer-implemented method of claim 16, wherein the plurality of symbol-bearing reels in the first enhanced array includes at least one enhanced-array trigger associated with the second enhanced array.

18. The computer-implemented method of claim 16, further comprising a bonus event in which a plurality of free spins is awarded, the unlocked associated array being unlocked during one of the free spins and remaining unlocked for any remaining ones of the free spins.

19. The computer-implemented method of claim 18, wherein an initial number of triggers of the plurality of enhanced-array triggers is modified during the bonus event to create an altered number of triggers.

20. The computer-implemented method of claim 19, wherein the altered number of triggers is greater than the initial number of triggers.
